(19) United States
(12) Patent Application Publication
(10) Pub. No.: US 2024/0320476 A1
(43) Pub. Date: Sep. 26, 2024

(54) SYSTEM AND METHOD FOR CAPTURING, MANAGING AND ENRICHING PROMPTS IN A DATA PROCESSING ENVIRONMENT

(71) Applicant: KPMG LLP, New York, NY (US)

(72) Inventor: Swaminathan CHANDRASEKARAN, Coppell, TX (US)

(21) Appl. No.: 18/616,027

(22) Filed: Mar. 25, 2024

Related U.S. Application Data
(60) Provisional application No. 63/454,475, filed on Mar. 24, 2023.

(51) Int. Cl. G06N 3/0475

(52) U.S. Cl. CPC G06N 3/0475

(57) ABSTRACT

A prompt capture and enrichment system having a prompt capture unit for receiving prompts from different data sources to form input prompts; a prompt enrichment unit for automatically enriching one or more prompt attributes of the input prompts and for generating enriched prompts; a prompt filtering unit for filtering the enriched prompts based on prompt attributes and then generating filtered prompts and for generating a truthfulness score associated with the filtered prompts indicative of a truthfulness of the filtered prompts; a prompt matching unit for matching one of the enriched or filtered prompts with one of the input prompts to determine if a match exists based on user information and prompt attributes; and a storage unit including a blockchain for storing the input prompts, the enriched prompts, and the filtered prompts.

### RELATED APPLICATION

The present application claims priority to U.S. provisional patent application Ser. No. 63/454,475, filed on Mar. 24, 2023, and entitled System and Method For Capturing, Managing, and Enriching Prompts in a Data Processing Environment, the contents of which are herein incorporated by reference.

### BACKGROUND OF THE INVENTION

The present invention relates to generative artificial intelligence models, and more particularly relates to the capture and enrichment of prompts for processing by the generative artificial intelligence models.

Generative artificial intelligence (AI) models can beneficially and quickly generate elaborate and refined outputs based on one or more input prompts. Occasionally, the generative AI models are capable of generating outputs that are more strongly preferred by users than content generated by humans. Thus, the use of generative AI models to generate content is expanding rapidly.

Despite the benefits of generative AI models, the models still possess a number of disadvantages. The generative AI models can often generate answers that are incorrect or nonsensical, but even when this is the case, the generated answers can initially appear plausible to the casual observer. The use of generative AI models thus pose concerns from a usability, reliability and an intellectual property infringement perspective. In particular, the use of generative AI models can potentially create copyright infringement issues as prompts used in generative AI models or outputs generated by the models can potentially infringe upon the prompts or other works of copyright owners. Further, the outputs generated by the generative AI models are only as good as the input prompts that are created by the user and ingested by the generative AI models.

The prompts serve as an input into the generative AI models and can help guide the models. The prompts are thus an essential element of how a user interacts with the generative AI models. Further, the prompts often play an important role in the behavior and performance of different types of generative AI models, including large language models (LLM), diffusion models, transformer architectures, and the like. The input provided by the prompts can be instructive to the generative AI model, with the prompts providing instructions, questions, examples or precedents. If poorly constructed prompts are provided as inputs into the generative AI models, then the outputs generated by the models are of relatively poor quality. The prompts can also be less effective when the prompts include biased or toxic material.

Additionally, users are often hesitant to construct and provide prompts for use in the generative AI models. One issue with users providing the prompts is that the prompts are subsequently shared and used as input data for other generative AI training models, and hence the user has quickly lost control of the use of the prompt. Thus, the users are often reluctant to provide prompts since the user cannot control the subsequent use thereof. Further, enterprises in the generative AI model field often recommend that users avoid utilizing any sensitive data in the prompts. For prompts related to sensitive topics, the prompt owners are often reluctant to share their prompts, resulting in less training data for generative AI models based on those topics and potentially a lower quality of outputs generated by the models for sensitive topics. Additionally, users often have little incentive to make the prompts available for the use in the generative AI models.

The prompts are conventionally created by individuals or companies over time. Some of the prompts are highly useful and are frequently reused. However, the prompts are often made available only to a limited audience. In some instances, prompts only exist in rudimentary forms such as in a spreadsheet software. The prompts can also reside non-digitally with subject matter experts or other individuals who know about a particular domain, and the subject matter experts are not available all the time. The prompts can also be undocumented and can be followed or created using ad-hoc approaches, such as via word-of-mouth or via tribal knowledge within an enterprise. Because the number of effective prompts from trusted sources can be limited and difficult to locate and aggregate, users often resort to using fewer effective prompts from other sources, leading to reduced quality in the outputs generated by the generative AI models.

### SUMMARY OF THE INVENTION

The present invention is directed to a prompt capture and enrichment system that actively captures prompts and then enriches and filters the content of the prompts. The prompt capture and enrichment system receives prompts from various data sources and enriches the prompts in various ways. Enrichment of a prompt can increase the ease in which a subsequent user can determine that the prompt is a relevant and/or effective prompt for that subsequent user's intended purpose. The prompt capture and enrichment system can also assess the truthfulness of prompts and can filter prompts having a low truthfulness score. The truthfulness score can be determined based on a high degree of similarity to an existing prompt that can be indicative of copyright issues or plagiarism, and the truthfulness score can also be determined based on the amount of propaganda, polarity or toxicity in scores. Enriched prompts and/or prompts that have been filtered can be stored in a storage unit including a blockchain, and prompts can be retrieved from storage for subsequent use by the system or for specific users where those users have been matched based on one or more parameters.

The prompts can be used as inputs to one or more generative artificial intelligence or machine learning (ML) models. The prompt capture and enrichment system can be used by various users. Potential users can include enterprises, crowdsourcing users, and people or entities that are facilitating an exchange and managing how content is distributed. The present invention can further include the sourcing, verifying and matching of knowledge assistants, domain embeddings, and artificial intelligence agents forming part of the input prompt to enhance the sourcing, cataloguing, discovery, and matching of prompts for generative language models.

The present invention can be directed to a computer-implemented prompt capture and enrichment system for capturing and enriching prompts for use in a generative language model. The system can include a prompt capture unit for receiving a plurality of the prompts from a plurality of different data sources to form input prompts; a prompt enrichment unit for automatically enriching one or more prompt attributes of the input prompts and for generating a plurality of enriched prompts; a prompt filtering unit for filtering the plurality of enriched prompts based on one or more of the prompt attributes for generating a plurality of filtered prompts and for generating a truthfulness score associated with the filtered prompt indicative of the truthfulness of the filtered prompts; a prompt matching unit for matching one or more of the plurality of enriched prompts or filtered prompts with one or more of the input prompts to determine if a match exists based on user information and one or more of the prompt attributes; and a storage unit including a blockchain for storing one or more of the plurality of input prompts, the plurality of enriched prompts, and the plurality of filtered prompts.

The prompt enrichment unit can include an ontology model unit for storing a plurality of ontology models that are domain specific and for applying one or more of the plurality of ontology models to one or more of the plurality of input prompts, where the ontology model is related to the input prompts based on an analysis of the prompt attributes and identifies one or more relevant concepts, entities or relationships in the ontology model that are related to the input prompt. The ontology model unit can then generate an ontology prompt. The prompt enrichment unit can further include a prompt enrichment subsystem for enriching the ontology prompts by adding one or more prompt attributes thereto and for generating the plurality of enriched prompts.

The prompt enrichment subsystem can include any number of (e.g., one or more of, two or more of, three or more of, four or more of, and the like) the foregoing units, and can according to one embodiment include two or more of a prompt context enrichment unit for receiving the ontology prompt and for enriching one or more contextual attributes of the ontology prompt with contextual data to enrich the ontology prompt; an auto-prompt classifier unit for automatically classifying the ontology prompt into one or more categories based on one or more of the prompt attributes; a prompt efficacy predictor unit for applying to the ontology prompt one or more machine learning models to predict an effectiveness of the ontology prompt in generating a relevant and accurate output by the generative language model; a multi-factorial authorship profiling unit for identifying an author of the ontology prompt by analyzing multiple different language related prompt attributes of the ontology prompt and then determining the author thereof; and a multi-dimensional consent management unit for analyzing rights attributes associated with the ontology prompt to ensure that the user has one or more rights in the ontology prompt. The auto-prompt classifier unit can employ a categorization specific machine learning model to categorize the ontology prompts into one or more of the categories, where the categorization specific machine learning model is pretrained on a plurality of prelabeled input prompts and corresponding categories that include the prompt so as to be able to select an accurate category for the ontology prompt. The prompt efficacy predictor unit can include an efficacy related machine learning model to determine a relevance of an output of the generative language model based on the ontology prompt. The efficacy related machine learning model can be pretrained on prompts and related outputs so as to analyze one or more attributes of the ontology prompt to predict a relevance of the output of the generative language model processing the ontology prompt. The prompt enrichment unit can further include a prompt validation unit for receiving and processing one or more of the enriched prompts and for evaluating and validating a selected prompt attribute of the enriched prompt. The prompt enrichment subsystem further can comprise a digital conversion unit for converting one or more of the input prompts and one or more of the plurality of enriched prompts into a digital asset.

The prompt filtering unit can further include any number of the foregoing units, and can include, according to one embodiment, a prompt language filtering unit for filtering the language of the plurality of the enriched prompts and for generating an output language truthfulness score indicative of the degree of truthfulness in the language of the enriched prompt; an existing prompt detection unit for determining the similarity of the enriched prompt to the input prompt and for generating an output similarity score that is indicative of the similarity of the enriched prompt to the preexisting prompt; and a scoring unit for generating an aggregated truthfulness score based on the truthfulness score generated by the prompt language filtering unit and on the similarity score generated by the existing prompt detection unit.

The prompt language filtering unit can include any combination of a propaganda detection unit for detecting the presence of propaganda within the language of the enriched prompt and for generating a propaganda score that is indicative of a degree of likelihood that the enriched prompt includes propaganda, a polarity detection unit for detecting the presence of polarity in the language of the enriched prompt and for generating a polarity score that is indicative of a degree of polarity in the enriched prompt, and a toxicity detection unit for detecting the presence of toxicity in the language of the enriched prompt and for generating a toxicity score that is indicative of a degree of toxicity in the enriched prompt.

The present invention an also include a prompt matching unit for matching together one or more of the input prompts with one or more of the enriched prompts, where the prompt matching unit includes a prompt recommendation unit for recommending one or more of the enriched prompts to a user. The prompt recommendation unit can include any combination of, and according to one embodiment includes two or more of a multi-factorial cohort matching unit for recommending one or more of the enriched prompts to one or more users based on the attributes associated with the enriched prompt and based on selected user information; a prompt similarity recommender unit for recommending one or more of the enriched prompts to the user based on a similarity of the enriched prompts to one or more other prompts used by the user; an in-the-moment recommender unit for recommending one or more of the enriched prompts to the user based on user input provided by the user; and a geofenced prompt recommendation unit for recommending one or more of the enriched prompts to the user based on a location of the user.

The prompt matching unit can further include any combination of a simple context prompt matching unit for detecting input prompts and then matching one or more of the input prompts with one or more of the enriched prompts by determining a best match score by comparing one or more prompt attributes of the input prompt with one or more prompt attributes of the enriched prompt; a trending prompt unit for identifying one or more of the enriched prompts that are popular based on one or more popularity attributes associated with the enriched prompts; and an authorship profile matching unit employing a text analysis technique for analyzing language attributes associated with each of the enriched prompt and the input prompt and then identifying an author of the enriched prompt based thereon.

The present invention is also directed to a computer-implemented method for capturing and enriching prompts. The method can include receiving a plurality of input prompts from a plurality of different data sources; enriching one or more prompt attributes of the input prompts and for generating based thereon a plurality of enriched prompts; filtering the plurality of enriched prompts based on one or more of the prompt attributes and generating in response a plurality of filtered prompts, and for generating a truthfulness score associated with the filtered prompts indicative of a truthfulness of the enriched prompts; matching one or more of the plurality of enriched prompts or filtered prompts with one or more of the input prompts to determine if a match exists based on user information and one or more of the prompt attributes; and storing one or more of the plurality of captured prompts, the plurality of enriched prompts, and the plurality of filtered prompts.

The method of the present invention can further include storing a plurality of ontology models that are domain specific and applying one or more of the plurality of ontology models to one or more of the plurality of input prompts, wherein the ontology model is related to the input prompts based on an analysis of the prompt attributes and identifies one or more relevant concepts, entities or relationships in the ontology model that are related to the input prompt, and generating in response an ontology prompt.

The method can also include any combination of enriching the ontology prompts by adding one or more prompt attributes thereto and generating the plurality of enriched prompts; receiving the ontology prompt; and enriching the ontology prompt with contextual data to enhance the ontology prompt.

The method of the present invention can further include automatically classifying the ontology prompt into one or more categories based on one or more of the prompt attributes. Still further, the method can include receiving the ontology prompt, and applying to the ontology prompt one or more machine learning models to predict an effectiveness of the ontology prompt in generating a relevant and accurate output by the generative language model.

The present invention can be configured to identify an author of the ontology prompt by analyzing multiple different language related prompt attributes of the ontology prompt and then determining the author thereof. Further, the can include receiving one or more of the enriched prompts, processing one or more of the enriched prompts, and evaluating and validating a quality of the one or more of the enriched prompts.

The method of the present invention can employ a categorization specific machine learning model to categorize the ontology prompts into one or more of the categories, where the categorization specific machine learning model is pretrained on a plurality of prelabeled input prompts and corresponding categories that include the prompt so as to be able to select an accurate category for the ontology prompt.

The method of the present invention can determine a relevance of an output of the generative language model based on the ontology prompt and employ an efficacy related machine learning model that is pretrained on prompts and related outputs so as to analyze one or more attributes of the ontology prompt to predict a relevance of the output of the generative language model processing the ontology prompt.

The method of the present invention can also filter a language attribute of the plurality of the enriched prompts and generate an output language truthfulness score indicative of the degree of truthfulness in the language of the enriched prompt. The method can still further include determining a similarity of the enriched prompt to the input prompt, and generating an output similarity score that is indicative of the similarity of the enriched prompt to the preexisting prompt. The method is also directed to generating an aggregated truthfulness score based on the truthfulness score and on the similarity score.

The method of the present invention can include detecting the presence of propaganda within the language of the enriched prompt, and generating a propaganda score that is indicative of a degree of likelihood that the enriched prompt includes propaganda; and/or detecting the presence of polarity in the enriched prompt, and generating a polarity score that is indicative of a degree of polarity in the enriched prompt; and/or detecting the presence of toxicity in the enriched prompt, and generating a toxicity score that is indicative of a degree of toxicity in the enriched prompt. The present invention can then match together one or more of the input prompts with one or more of the enriched prompts.

The method of the present invention can also recommend one or more of the enriched prompts to a user based on the attributes associated with the enriched prompt and based on selected user information; and/or recommending one or more of the enriched prompts to the user based on a similarity of the enriched prompts to one or more other prompts used by the user; and/or recommending one or more of the enriched prompts to the user based on user input provided by the user; and/or recommending one or more of the enriched prompts to the user based on a location of the user.

The method of the present invention can detect input prompts and then match one or more of the input prompts with one or more of the enriched prompts by determining a best match score by comparing one or more prompt attributes of the input prompt with one or more prompt attributes of the enriched prompt; identify one or more of the enriched prompts that are popular based on one or more popularity attributes associated with the enriched prompts; and employ a text analysis technique for analyzing language attributes associated with each of the enriched prompt and the input prompt and then identifying an author of the enriched prompt based thereon.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of a prompt capture and enrichment system according to the teachings of the present invention.

FIG. 2 is a more detailed schematic block diagram of the prompt capture and enrichment system of FIG. 1 according to the teachings of the present invention.

### DETAILED DESCRIPTION OF THE INVENTION

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “source data” can include any type of data from any suitable source that would benefit from being converted into a more usable form. The source data can include, for example, financial related data. The source data can be in hard copy or written form, such as in printed documents, or can be in digital file formats, such as in portable document format (PDFs), word processing file formats such as WORD documents, as well as other file formats including hypertext markup language (HTML) file formats and the like. It is well known in the art that the hard copies can be digitized and the relevant data extracted therefrom.

As used herein, the term “enrich,” “enriched” or “enriching” is intended to include the ability to ingest, integrate, augment, improve and/or enhance data by supplementing missing or incomplete data, correcting inaccurate data, adding additional data, or processing the data using known techniques, such as with artificial intelligence, machine learning and risk modelling techniques, and then applying logic and structure to the data so as to curate the data. The term enrich can also include the ability to correlate factors to the data so as to generate or create meaningful insights and conclusions based on the data, including environmental and financial data. In the context of prompts, the prompts can be enriched by adding more context, detail, or specificity in order to better guide or instruct a machine learning model a conversation or direct the output of the model towards a desired outcome. This can involve providing additional information, constraints, examples, or specifications that help the model generate a more relevant and tailored response.

As used herein, the term “machine learning” or “machine learning model” is intended to mean the application of one or more software application techniques that process and analyze data to draw inferences from patterns in the data. The machine learning techniques can include a variety of artificial intelligence (AI) and machine learning (ML) models or algorithms, including supervised learning techniques, unsupervised learning techniques, reinforcement learning techniques, knowledge-based learning techniques, natural-language-based learning techniques such as natural language generation and natural language processing, deep learning techniques, and the like. The machine learning techniques are trained using training data. The training data is used to modify and fine-tune any weights associated with the machine learning models, as well as record ground truth for where correct answers can be found within the data. As such, the better the training data, the more accurate and effective the machine learning model can be.

As used herein, the term “data object” can refer to a location or region of storage that contains a collection of attributes or groups of values that function as an aspect, characteristic, quality, entity, or descriptor of the data object. As such, a data object can be a collection of one or more data points that create meaning as a whole. One example of a data object is a data table, but a data object can also be data arrays, pointers, records, files, sets, and scalar type of data.

As used herein, the term “attribute” or “data attribute” is generally intended to mean or refer to the characteristic, properties or data that describes as aspect of a data object or other data. The attribute can hence refer to a quality or characteristic that defines a person, group, or data objects. The properties can define the type of data entity. The attributes can include a naming attribute, a descriptive attribute, and/or a referential attribute. The naming attribute can name an instance of a data object. The descriptive attribute can be used to describe the characteristics or features or the relationship with the data object. The referential attribute can be used to formalize binary and associative relationships and in referring to another instance of the attribute or data object stored at another location (e.g., in another table). When used in connection with prompts for use with a generative language model, the term is further defined below.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “electronic device” can include servers, controllers, processors, computers, tablets, storage devices, databases, memory elements and the like.

The present invention is directed to a system and method for capturing and enriching prompts that can be used as inputs to one or more generative artificial intelligence (AI) or machine learning (ML) models. The enriched prompts can be stored as part of a catalogue of prompts that can be subsequently used by the system. As used herein, the term “prompt” is intended to mean specific natural language input data that is received and processed by a machine learning model, such as a generative AI model, to elicit a desired response from the model. The input can consist of text, data, images, or other forms of information tailored to elicit a desired response from the model. The prompt can thus take any form and can include any combination of one or more instructions, one or more questions, one or more examples, and the like. The prompt serves as an input or starting point for the model and helps direct the model to generate an output, such as text, images, predictions, or classifications. The prompt can vary in complexity and format depending on the type of model, and the tasks and the capabilities of the model. Specifically, the prompt can be a piece of text or data that is inputted into a generative language model in order to generate new content that is related to or follows from the data input. The prompt helps guide the generative language model towards generating an output that is relevant and coherent based on the given input. The generative language model then generates a continuation of the input text based on knowledge learned from training data. By simple way of example, the prompt can be a sentence or a longer string of text or an image, and the prompt can be used to initiate the generative process in the language model. The term prompt can also encompass not only a query or instruction input by a user but can also include or encompass the integration of additional elements, such as domain-specific Knowledge Assistants, Artificial Intelligence Agents, and Domain Embeddings. The prompt can thus be a comprehensive interaction element or composite construct, which can summon and leverage the specialized capabilities of the Knowledge Assistants to retrieve and synthesize information from domain-specific corpora, the Artificial Intelligence Agents to autonomously operate and execute tasks within a given domain in an enterprise, and the Domain Embeddings to represent the knowledge and semantic relationships intrinsic to domain-specific corpora. The prompt can thus provide a comprehensive, intelligent, and dynamic framework for the sourcing, cataloging, discovering, and matching of prompts in a multi-sided artificial intelligence system.

The Knowledge Assistants can be AI-powered systems that are configured to help users discover, search, summarize, synthesize, and compare information from a specific domain within an enterprise. Specifically, the knowledge assistant is an intelligent component embedded in the system 10 that can be configured to manage and leverage knowledge resource to facilitate the acquisition, organization, retrieval, and dissemination of information or knowledge, enhancing the system's ability to assist users with various tasks and inquiries. The Knowledge Assistant can employ natural language processing techniques and machine learning models to analyze and understand user queries, retrieve relevant information from structured and unstructured data sources, and present insightful responses or recommendations to the users. The Knowledge Assistant can operate through a combination of software modules, databases, and interfaces that enable seamless interaction with users and data sources.

The Domain Embeddings allow the Knowledge Assistants to process and understand natural language queries and provide relevant and accurate responses. As such, the Domain Embeddings can refer to vector representations of specific knowledge domains or subject areas. The embeddings can be generated using selected techniques, such as word embeddings or neural network models trained on domain-specific data. The Domain Embeddings capture the semantic relationships between terms, concepts, or entities within a particular domain, thus allowing the system to better understand domain-specific information. The embeddings enable tasks such as information retrieval, classification, and recommendation within a specific domain by encoding the underlying structure and semantics of the domain's knowledge space into a numerical representation that can be processed by selected machine learning models.

The Artificial Intelligence (AI) Agents operate with varying degrees of autonomy within the system, utilizing an array of tools and techniques to perform tasks on behalf of the users. These elements serve as advanced facilitators for the dynamic and intelligent cataloging and retrieval processes. Specifically, the AI agents can be autonomous entities or software programs endowed with artificial intelligence capabilities that are designed to perform specific tasks or assist users in various domains. The AI agents utilize algorithms, machine learning models, and data to perceive their environment, generate decisions, and autonomously interact with users or other systems. The AI agents can range from simple rule-based systems to sophisticated neural network architectures, depending on the complexity of the tasks they are intended to handle. The agents can operate independently or collaborate with other agents to achieve overarching goals, serving as intelligent counterparts that augment human capabilities or automate repetitive tasks within the system.

As used herein, the term “generative model,” “generative AI model” or “generative language model” is intended to refer to a category of artificial intelligence and machine learning language models that generate new outputs based on data on which the model has been trained. Unlike traditional models that are designed to recognize patterns in the input data and make predictions based thereon, the generative language models generate new content in the form of images, text, audio, hieroglyphics, code, simulations, and the like. The language models are typically based on large language models or deep learning neural networks, which can learn to recognize patterns in the data and generate new data based on the identified patterns. The language models can be trained with training data on a variety of data types, including text, images, and audio, and can be used for a wide range of applications, including image and video synthesis, natural language processing, music composition, and the like. Typically, generative language models can employ a type of deep learning model called generative adversarial network (GAN) that includes two neural networks that work together to generate new data. The generative language model can also optionally employ recurrent neural networks (RNNs), which are a type of neural network that is often used for natural language processing tasks. The RNNs are able to generate new text by predicting the likelihood of each word given the context of the previous words in the sentence. The generative AI model can also optionally employ a transformer model, which is a type of neural network architecture that is often used for language modeling tasks. The transformer model is able to generate new text by attending to different parts of the input text prompt and learning the relationships between the parts. Variational autoencoders (VAEs) can also be used and are a type of generative language model that learns to represent the underlying structure of a dataset in a lower-dimensional latent space. The model then generates new data points by sampling from this latent space. Deep convolutional generative adversarial networks (DCGANs) can also be employed and are a type of GAN that uses convolutional neural networks to generate realistic images. The DCGAN model is commonly used for image synthesis tasks, such as generating new photos or realistic textures.

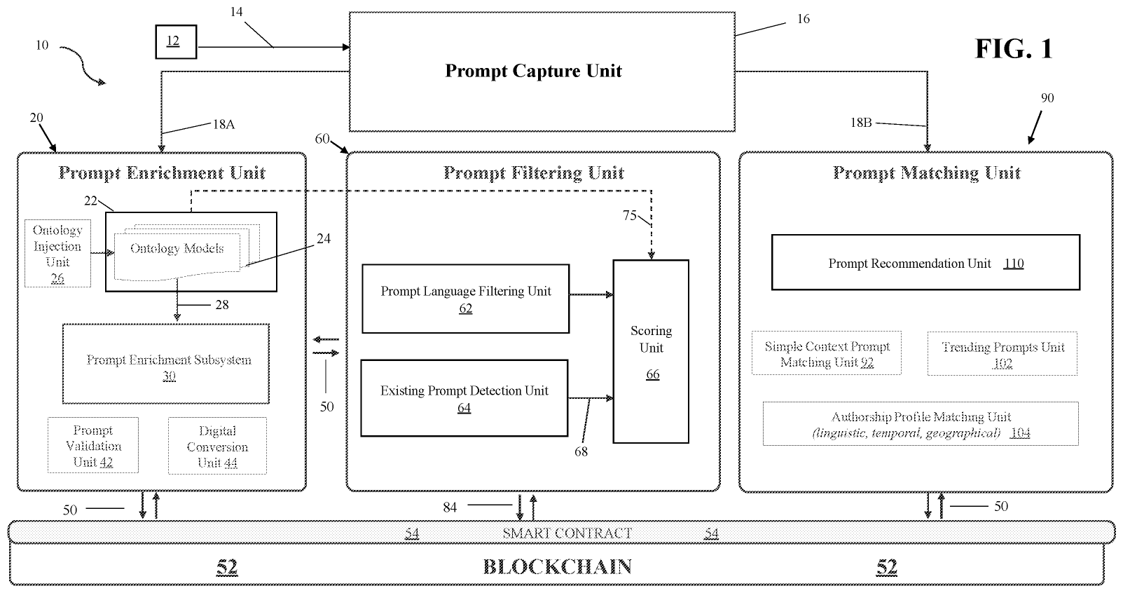

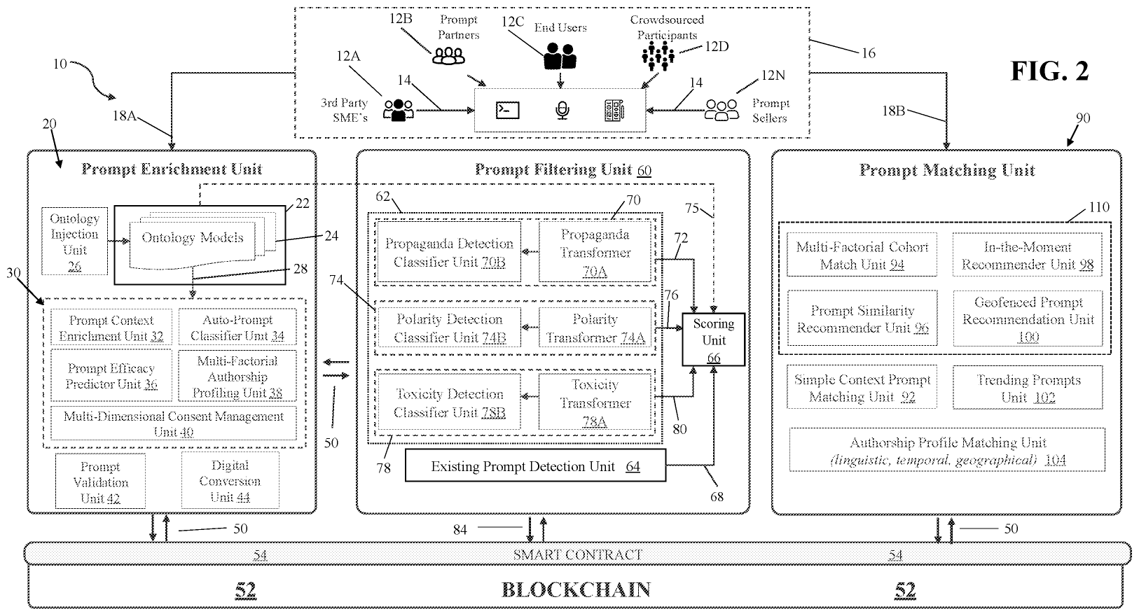

The prompt capture and enrichment system 10 of the present invention identifies, captures, and manages prompts that produce effective results in a variety of domains that allow for wider use and fine tuning of the generative language models. The prompts can also serve to fine tune and/or train the generative language models. The system of the present invention thus addresses the need to capture, source, enrich, manage, and govern prompts and allows the prompts to be employed by the system and to be optionally shared with third parties. An example of one embodiment of the prompt capture and enrichment system of the present invention is shown for example in FIGS. 1 and 2. The illustrated prompt capture and enrichment system 10 has a prompt capture unit 16 that captures or receives prompts 14 from a variety of different types of data sources 12. The data sources 12 can include, for example, subject matter experts 12A, third party sources such as partners 12B, end users 12C, crowd sourced participants 12D, prompt sellers 12N, and the like. The prompt capture unit 16 can be configured to continuously capture prompts. The prompts 14 are captured by the prompt capture unit 16 and the captured prompts 18A are conveyed to a prompt enrichment unit 20.

The prompt enrichment unit 20 enriches the prompts 18A by manipulating, such as ingesting, integrating, adding or modifying, one or more attributes associated with the prompts 18A so as to modify, enrich and curate the prompts 18A. Specifically, the prompt enrichment unit 20 can be configured to enrich the prompt by adding additional context, information, or details to the prompts to make the prompt 18A more specific, relevant, and/or useful for generating a higher-quality response from a generative language model. For example, the prompt 18A can be enriched by adding contextual data to help clarify the scope and purpose of the prompt 18A or the prompt 18A can be enriched by modifying or adjusting the scope of the prompt 18A. The prompt enrichment unit 20 can be configured to add any additional context, information, or details in metadata of the prompts 18A. This additional material in the metadata can be used to facilitate searches for the prompts 18A. The prompt enrichment unit 20 can enrich the prompt 18A so that the prompt 18A can be more easily identified for subsequent users. Additional information added to the metadata for prompts can include an identifier to enable a determination of the prompt author, information about the prompt context, location information for the prompt author or the prompt provider, or a prompt creation time, a prompt sharing time. Other information can also be stored in metadata associated with prompts 18A. The term “attribute(s)” when associated with prompts, as used herein, refers to specific characteristics, qualities, properties or features of the prompt that define the instructions or input provided to the generative language model. The attributes can influence how the model interprets the input data and generates corresponding outputs, and can include factors such as clarity, specificity, relevance, consistency, completeness, balance, flexibility, engagement, contextualization, and customizability. With regard to balance, the prompt needs to provide a balance between simplicity and complexity, depending on the task complexity and model capability. With regard to flexibility, the prompts should allow for variations in input while still yielding meaningful outputs. The prompts should be engaging (e.g., engagement) to encourage the model to generate creative or accurate responses, and the prompts should consider the context (e.g., contextualization) of the task to generate relevant responses. The attributes serve to guide the model's behavior and facilitate the generation of accurate and meaningful responses. The attribute can also include the metadata associated with the prompt.

The illustrated prompt enrichment unit 20 can include an ontology model unit 22 for storing a series of ontology models 24. The ontology models 24 can be domain specific ontology models. The ontology model unit 22 can automatically select, or the ontology model unit 22 can receive model selection instructions to select, an ontology model 24, such as a domain specific ontology model, from the set of ontology models that is related to the type of prompt 18A received by the prompt enrichment unit 20. The system can automatically update the ontology models 24 in the ontology model unit 22 by injecting or adding additional ontology models via an ontology injection unit 26. The ontology models 24 are each a formal and explicit specification of the concepts, entities, and relationships that exist within a particular domain of knowledge. The ontology models 24 are a way of representing knowledge in a structured and organized manner using a set of concepts and relationships that are defined by a shared vocabulary. The ontology models 24 typically consist of a set of classes or concepts that represent the entities or objects within the domain, and a set of relationships that describe how those entities are related to each other. The ontology models 24 can also include a set of axioms or rules that define the properties and behaviors of the entities and relationships. The ontology models 24 can be used to support automated reasoning, data integration, and knowledge sharing across different systems and domains. The ontology model thus refers to a structured representation of knowledge that defines the concepts, entities, relationships, and constraints within a particular domain, and serves as a formalized framework for organizing and categorizing information, allowing for semantic interoperability and knowledge sharing among different systems and applications. The ontology model can include a taxonomy of classes and subclasses, along with properties and instances, facilitating the representation, integration, and reasoning of domain-specific knowledge. An advantage of employing the ontology models 24 is that they provide a shared vocabulary or language for representing and communicating knowledge within a particular domain. The shared vocabulary helps reduce ambiguity and inconsistency in the use of selected terminology used within the domain. The ontology models 24 stored in the ontology model unit thus have a set of concepts and categories in a subject area or domain that sets forth the properties of the concepts and the relationship between the concepts. The ontology models 24 thus define a common vocabulary for the domain. The ontology model with a domain applicable to the input prompt 18A can be selected, and the ontology model can analyze and interpret the input prompt 18A in the context of the domain that it represents. According to one embodiment, the ontology model can map the concepts and entities provided in the prompt to corresponding elements in the ontology model.

The ontology models 24 can then generate ontology prompts 28, and the ontology models 24 can serve to enrich the captured input prompts 18A by providing a structured and organized representation of the concepts, entities, and relationships within a particular domain that are associated with the prompt. For example, the ontology models 24 can provide a shared vocabulary, which includes a set of standardized terms and definitions that can be used to describe the concepts and entities within a particular domain. The structured terms help to ensure that the ontology prompt 28 is clear and unambiguous, hence enhancing the quality of the responses generated by the generative language model. The ontology models 24 can also enrich the captured prompt 18A by identifying relevant concepts and entities that are related to the captured prompt 18A. The concepts can help ensure that the response generated by the generative language model based on the ontology prompt 28 is focused and relevant. The ontology models 24 can also provide a set of predefined relationships between the concepts and entities within a particular domain. The identified relationships can help suggest possible connections or relationships between the prompt 18A and other related concepts or entities and can also provide a useful starting point for generating a response. The information from the ontology models 24 thus enables the prompt enrichment unit 20 to better understand the prompt 18A and the context of the prompt 18A. The ontology model unit 22 can then generate an ontology prompt 28 that is conveyed to a prompt enrichment subsystem 30 for further enriching the ontology prompt 28.

The prompt enrichment subsystem 30 can further enrich the ontology prompt 28 to add further enrichment information. For example, the illustrated prompt enrichment subsystem 30 can optionally include a prompt context enrichment unit 32 for adding additional contextual information to the ontology prompt 28. Specifically, the prompt context enrichment unit 32 can enhance or enrich the ontology prompt 28 by adding further contextual information or details to the ontology prompt 28 to make the ontology prompt 28 more specific, relevant, and useful for generating a high-quality response from the generative language model. The additional contextual data can include providing additional background information, modifying or adjusting the scope (e.g., narrowing down the focus) of the ontology prompt 28, providing specific examples or scenarios, employ visual aids, and clarifying the desired outcome by the generative language model. The prompt context enrichment unit 32 provides a clarified and unambiguous ontology prompt 28 that guides the generation of a high-quality response. By providing additional context, information, and examples, the ontology prompt 28 becomes enhanced by being more specific and relevant, thus making it easier to generate a response that meets the desired outcome. The prompt context enrichment unit 32 can employ machine learning models, such as natural language processing techniques, to analyze the ontology prompt 28 in order to enhance the ontology prompt 28 by providing more specific and relevant contextual information.

The prompt enrichment subsystem 30 can also optionally include an auto-prompt classifier unit 34 for automatically classifying the ontology prompts 28 into one or more predefined classifications or categories associated with desired outputs of the generative language model. The auto-prompt classifier unit 34 enables automated processing and response generation for various applications, such as chatbots, search engines, recommendation systems, and the like. The auto-prompt classifier unit 34 can employ one or more machine learning models, where the model is trained on labeled examples of input prompts and corresponding categories that include the prompt. The machine learning model then learns to recognize patterns in the ontology prompts 28 and predict an appropriate category for new, unseen prompts. The auto-prompt classifier unit 34 can then automatically classify the incoming ontology prompts 28 based on the various classifications associated with predefined output actions to be generated by the generative language model and trigger an appropriate response or action. This helps improve and enhance the efficiency and accuracy of the prompt capture and enrichment system 10, as it eliminates the need for human intervention in categorizing the ontology prompts 28 and improves the processing speed of the system by automatically performing the classification methodology. The categorization of the ontology prompts 28 allows the prompt capture and enrichment system 10 to place or assign a category to the enriched prompts and optionally to create a new classification if needed if the ontology prompt cannot be assigned to a preexisting category. For example, the prompts can be classified into topic categories based on subject matter associated with the prompt, an intent category based on an intent or purpose associated with the prompt, a complexity level category associated with a complexity of the prompt, a format category based on the format of the prompt (e.g., question, statement, etc.), a tone or sentiment category based on the tone or sentiment associated with the prompt, domain-specific categories, and the like. The prompt categories can also optionally include an ethical inquiry related category, a specialty creative generation category, and a highly sensitive prompt category. Additionally, the system is equipped to infer and classify or categorize the prompts specifically related to an invocation or utilization of the Knowledge Assistants or AI Agents, further diversifying the comprehensive nature of the system 10 of the present invention. Specifically, the categories can include a Knowledge Assistant engagement prompt category that can include prompts that are specifically designed to summon or engage Knowledge Assistants for the purpose of accessing, summarizing, or synthesizing domain-specific information from a corresponding corpus or corpora specific to that domain. This can range from requesting regulatory compliance insights to seeking comparative analysis of trade regulations. The categories can also include an AI Agent tasking category that encompasses prompts that are formulated to assign tasks, gather information, or execute actions through the use of AI Agents. The prompts of this type can specify the objective, the domain of operation, and the degree of autonomy expected from the AI Agent, thus facilitating a broad spectrum of interactions from simple information retrieval to complex decision-making tasks. The prompt categories can further include a Knowledge Navigation and Discovery category that categorize prompts that leverage the capabilities of both Knowledge Assistants and AI Agents for the purpose of navigating and discovering pertinent information across domain-specific datasets. These prompts may seek to uncover hidden patterns, compare against historical data, or predict future trends based on the ingested information.

The prompt enrichment subsystem 30 can also include an optional prompt efficacy predictor unit 36 that employs one or more machine learning models designed or configured to predict an effectiveness of the ontology prompt 28 in generating relevant and useful output or responses from the model. The prompt efficacy predictor unit 36 can thus identify the ontology prompts 28 that are likely to result in accurate and relevant output by the generative language model. An accurate output is one that is correct in all included details and that is presented using appropriate syntax. According to one embodiment, the prompt efficacy predictor unit 36 can employ a dataset of ontology prompts 28 and corresponding output. The machine learning model employed by the prompt efficacy predictor unit 36 is then trained to analyze one or more features or attributes of the ontology prompt 28, such as the language used in the prompt, the specificity of the query associated with the prompt, and the context of the prompt, in order to predict a quality, relevance and/or accuracy of the output of the generative language model. For example, if the prompt efficacy predictor unit 36 identifies an ontology prompt 28 as likely to result in a low-quality output by the generative language model, then the prompt efficacy predictor unit 36 can adjust an overall response generation strategy or request additional information from the system or user to improve the quality or truthfulness of the ontology prompt 28 and hence the response of the generative language model.

The prompt enrichment subsystem 30 can further optionally include a multi-factorial authorship profiling unit 38 for identifying an author of the ontology prompt 28 and associated textual information by analyzing one or more different attributes (e.g., characteristics or features) of the ontology prompt 28. The multi-factorial authorship profiling unit 38 can create a detailed profile of an author based on selected attributes or characteristics, such as language attributes. The language attributes can include writing style, vocabulary, and syntax and grammar. With regard to the syntax, the multi-factorial authorship profiling unit 38 can analyze the structure and punctuation in the ontology prompt 28 since the syntax characteristics of the ontology prompt 28 can be unique to a specific author. The multi-factorial authorship profiling unit 38 can also analyze the vocabulary employed in the ontology prompt 28, since an author can use with a selected degree of frequency similar vocabulary, and as a result, the unit can provide insights into the writing style and preferences of the author. The multi-factorial authorship profiling unit 38 can also analyze sentiment in the ontology prompt 28, which can correspond to an emotional tone of the text employed by the ontology prompt 28. The sentiment can be an indicator of the author's personality and worldview. The multi-factorial authorship profiling unit 38 can also analyze writing style within the ontology prompt 28 and the domain-specific language used in the ontology prompt 28. The overall structure and organization of the prompt text, as well as the use of selected literary devices and techniques, can be used to identify the author. Further, the use of selected language related to a particular field or topic can provide insights into the author's background or expertise. The multi-factorial authorship profiling unit 38 can analyze one or more of these factors or characteristics to form a profile of the author. The author profile can be used for a variety of purposes, such as identifying the author of anonymous texts or detecting plagiarism in the ontology prompt 28. As such, the multi-factorial authorship profiling unit 38 can provide valuable insights into the writing style and characteristics of an author and can identify the author.

The multi-factorial authorship profiling unit 38 can also analyze certain demographic information or personal information about the author, and this information can be considered as a factor in determining whether or not to recommend the ontology prompt 28 to other potential users having similar characteristics. The multi-factorial authorship profiling unit 38 can obtain data regarding characteristics such as age, occupation, or background can be obtained, but other characteristics can also be obtained.

The prompt enrichment subsystem 30 can still further include an optional multi-dimensional consent management unit 40 that can be employed to manage and obtain consent from prompt users or prompt authors in a variety of dimensions or contexts and/or to identify the rights the user has in using the prompt or the rights of the prompt authors in allowing use of the ontology prompt 28. The multi-dimensional consent management unit 40 can analyze the rights attributes associated with the ontology prompt 28 to help ensure that users have a clear understanding of what they are consenting to when using selected prompts generated by other authors, and that any author consent is obtained in a transparent and informed manner. The rights attributes can include, for example, author information, rights information associated with the use and ownership of the prompt, use consent information, prompt use information including frequency of use, prompt retention information, user information, and the like. For example, the multi-dimensional consent management unit 40 can determine the purpose for which data is being collected or used, such as marketing, research, or personalization. The multi-dimensional consent management unit 40 can also determine the extent to which the user's and author's data is shared or processed by third parties, the length of time for which the user's or author's data can be retained, and the context in which the user's or author's data is being collected or used, such as on a particular website or within a specific application. Thus, presenting users with ontology prompts 28 having additional attributes directed to one or more of foregoing rights obtained by the user can help ensure that the users have a clear understanding of what they are consenting to, and the user can thus make an informed decision about the use of the ontology prompt 28. The multi-dimensional consent management unit 40 can help where uncertainty is present as to whether user consent has been obtained in a transparent and informed manner, and the multi-dimensional consent management unit 40 can help build trust between users and enterprises that collect and use the data and authors.

The prompt enrichment subsystem 30 thus generates an enriched prompt 50 that can be stored in any selected storage device (e.g., electronic memory) or received and processed by any other selected portion of the prompt capture and enrichment system 10 by any suitable electronic device with any suitable processor. The prompt enrichment unit 20 can also include a prompt validation unit 42 for evaluating, verifying and validating a quality, relevance, and effectiveness of the enriched prompt 50. As used herein, the term “quality” is intended to mean that the prompt is clear, unambiguous, and properly aligned with the desired outcome or objective of the output of the generative language model. The prompt validation unit 42 employs advanced machine learning and natural language processing techniques not only to validate the structural and content quality of a prompt but also to enrich the prompt context, ensuring that the context is comprehensive and pertinent to the desired objective of the prompt. This process can include dynamically adding contextual information that enhances the prompt's relevance and utility for generating specific and accurate outputs. Furthermore, the prompt validation unit 42 can be configured to integrate prompt efficacy prediction, leveraging a sophisticated machine learning model to forecast the potential success of a prompt in generating the desired outcome. This prediction model can be pretrained or continually trained on a dataset of prompts characterized by clarity, unambiguity, and strong alignment with successful outcomes, thereby refining its ability to assess the future effectiveness of the prompt. Further, the prompt validation unit 42 can also optionally facilitate review by a subject matter expert that can analyze and validate the prompt by assessing the quality, relevance, and alignment of the prompt with a desired outcome of the generative language model. This expert review complements the automated processes, providing a nuanced understanding of the prompt's potential effectiveness and areas for improvement. The prompt validation unit 42 can also analyze a prompt for potential biases, ambiguities, or gaps in information before that prompt is output from the prompt enrichment unit 20 as an enriched prompt 50. The prompt validation unit 42 ensures the accuracy and effectiveness of enriched prompt 50 output from the prompt enrichment unit 20 and can thus improve the quality of the resulting output of the generative language model and minimize potential errors or biases. The enriched prompts 50 can include all prompts that have been output from the prompt enrichment unit 20 regardless of whether any changes have been made to the prompts or to data associated with the prompts. This comprehensive approach to prompt validation and enrichment, incorporating context enrichment and efficacy prediction, significantly elevates the quality and relevance of the prompts, thus facilitating the relatively easy and manageable cataloguing or categorizing of highly accurate and context-appropriate prompts.

The prompt enrichment unit 20 can also employ a digital conversion unit 44 for converting a prompt into one or digital forms. According to one embodiment, the digital conversion unit 44 can convert the ontology prompt 28 or an enriched prompt 50 into a non-fungible token (NFT). The ownership of the NFT represents ownership of the underlying digital asset, and can be bought, sold and traded like any other asset. The value of the NFT is determined by the demand for the underlying digital content it represents, as well as other factors such as scarcity and authenticity. The digital conversion unit 44 can optionally determine the amount of compensation to be provided to the prompt provider. For example, the digital conversion unit 44 can optionally provide compensation based at least partially on a number of times that the prompt has been used or the score for the prompt, which can be determined by the scoring unit 66, the digital conversion unit 44, or another unit in the prompt enrichment unit 20. The digital conversion unit 44 can optionally refrain from providing compensation until a score for the prompt is greater than or equal to a minimum threshold, and the digital conversion unit 44 can optionally provide compensation only where the score is greater than or equal to a minimum threshold. The digital conversion unit 44 can therefore provide an additional incentive to prompt authors and prompt owners to share their prompts.

The enriched prompts 50 output from the prompt enrichment unit 20 can be stored in any selected type of storage device. According to one embodiment, the enriched prompt 50 can be stored in a blockchain 52. In the blockchain 52, the enriched prompts 50 can be stored in a series of batches or blocks that include among other things a time stamp, a hash value of the data stored in the block, a copy of the hash value from the previous block, as well as other types of information, including for example the origins of the data. The blockchain 52 is shared with a plurality of nodes in a blockchain network in a decentralized manner with no intermediaries. Since many copies of the blockchain 52 exist across the blockchain network, the veracity of the data in the blocks can be easily tracked and verified. Each instance of new data from the data sources 12, prompts 18A or 28, or data and models and techniques employed by the prompt enrichment unit 20, can be stored in a block on the blockchain 52. The blockchain 52 thus functions as a decentralized or distributed ledger having data associated with each block that can be subsequently reviewed and/or processed. The data in the blockchain 52 can be tracked, traced, and presented chronologically in a cryptographically verified ledger format of the blockchain 52 to each participant of the blockchain 52. As such, the blockchain 52 can provide an audit trail corresponding to all of the data in the blocks, and thus can determine who interacted with the data and when, as well as the sources of the data and any actions taken in response to the data. According to one embodiment, each node of the blockchain network can include one or more computer servers which provides processing capability and memory storage. Any changes made by any of the nodes to a corresponding block in the blockchain 52 are automatically reflected in every other ledger in the blockchain 52. As such, with the distributed ledger format in the blockchain 52, provenance can be provided with the dissemination of identical copies of the ledger, which has cryptographic proof of its validity, to each of the nodes in the blockchain network. Consequently, all of the various types of data (e.g., original data, enriched data, the software and models and techniques employed to enrich the data, and the insights and recommendations generated therefrom) can be stored in the blockchain 52, and the blockchain 52 can be used to verify, prove and create an immutable record of the data, various rule based models and techniques, machine learning and artificial intelligence models and techniques, and enriched prompts 50, stored therein as well as to track users accessing the data and any associated insights generated by the prompt enrichment unit 20.

The illustrated blockchain 52 can employ a smart contract 54 for automatically enforcing the rules and conditions of a contract between parties. The smart contract 54 is essentially a computer program that runs on the blockchain 52 and is capable of executing and enforcing the terms of the contract without the need for intermediaries. The smart contract 54 can contain code that is triggered by specific conditions, such as the completion of a payment or the delivery of goods or services. Once the conditions of the contract are met, the smart contract 54 automatically executes the agreed-upon action, such as transferring funds or releasing a product. The smart contract 54 is secure, transparent, and immutable, meaning that once the smart contract 54 is deployed on the blockchain 52, the smart contract 54 cannot be altered or tampered with. The smart contract 54 can process incoming data that satisfies the predefined rules and generates new information or facts that are added to the ledger of the blockchain 52. The smart contract 54 thus enables enterprises to transact business with each other according to a set of common defined terms, data, rules, concept definitions, and processes. The smart contract 54 can be packaged into a chaincode which is deployed to the blockchain 52. As such, the smart contract 54 can be considered to govern transactions, whereas the chaincode governs how the smart contracts 54 are packaged for subsequent deployment. One or more of the smart contracts 54 can be defined within a chaincode. When the chaincode is deployed, all smart contracts 54 within it are made available to applications. An example of a system suitable for generating or employing a smart contract 54 in connection with documents is disclosed in U.S. Pat. No. 10,528,890, assigned to the assignee hereof, the contents of which are herein incorporated by reference.

At a basic level, the blockchain 52 immutably records transactions which update states in the ledger. The smart contract 54 can programmatically access two distinct pieces of the blockchain ledger, namely, a blockchain, which immutably records the history of all transactions, and a world state that holds a cache of the current value of these states. The blockchain 52 is the immutable ledger of all transactions that have occurred, where every transaction is reflected as an object recorded to the blockchain 52 in a discrete block. Each block of the chain contains an object key. Multiple transactions with the same object key can occur. The world state is in essence a database that sits on the blockchain 52 and holds current values for a given object key. The world state changes over time as new transactions reference the same object key. As a result, the blockchain 52 determines the world state, and the ledger is comprised of both the blockchain 52 and the world state. The smart contracts 54 primarily put, get and delete states in the world state, and can also query the immutable blockchain record of transactions. The “put” typically creates a new business object or modifies an existing one in the ledger world state. The “get” typically represents a query to retrieve information about the current state of a business object, and the “delete” typically represents the removal of a business object from the current state of the ledger, but not the history of the ledger.

Further, when the smart contract 54 executes, the smart contract 54 runs on a peer node that forms part of the blockchain network. The smart contract 54 takes a set of input parameters called the transaction proposal and uses them in combination with program logic to read from and write to the ledger. Changes to the world state are captured as a transaction proposal response, which contains a read-write set with both the states that have been read, and the new states that are to be written if the transaction is valid. The world state is not updated when the smart contract 54 is executed.

The enriched prompt 50 generated by the prompt enrichment unit 20 can also be conveyed to a prompt filtering unit 60 for performing one or more filtering operations or techniques on the language in the enriched prompt 50. The prompt filtering unit 60 can filter and detect for the presence of certain language within the enriched prompt 50 and determine if the language in the enriched prompt 50 previously existed. The prompt filtering unit 60 can then generate an output score that is indicative of the degree of truthfulness associated with the language in the enriched prompt 50. The degree of truthfulness is the level of factual correctness or accuracy for the enriched prompt 50 that considers the polarity and toxicity of content in the enriched prompt 50 and the likelihood that material constituting propaganda is in the content of the enriched prompt 50. The prompt filtering unit 60 can include a prompt language filtering unit 62 for filtering the language of the enriched prompt 50 to remove or modify rhetorical or unwanted language that is present within the enriched prompt 50. According to one embodiment of the present invention, the prompt language filtering unit 62 can optionally include a propaganda detection unit 70 that can be configured to detect propaganda language that can be present within the enriched prompt 50. As used herein, the term “propaganda” is intended to mean information, language or communication that is intended to influence or manipulate the opinions or beliefs of others or that can be used to promote a particular point of view or thing. The propaganda detection unit 70 can be used to detect language within the enriched prompt 50 that is determined to be biased or language that is designed to promote a particular agenda or ideology, but, in some embodiments, the detection of language within the enriched prompt 50 that is biased can be performed by other units such as the polarity detection unit 74. The propaganda detection unit 70 can also analyze the enriched prompt 50 to identify emotionally charged language or evidence of bias. The propaganda detection unit 70 can also analyze the source of the enriched prompt 50 to determine or consider the reliability of the data source. The propaganda detection unit 70 can also be configured to analyze the enriched prompt 50 to identify oversimplification or exaggeration of issues, or for the presence of logical fallacies. The propaganda detection unit 70 can also be configured to generate different scores based on the context for an enriched prompt 50, and the content of the enriched prompt 50 can potentially be considered propaganda in one context and not propaganda in another context. According to one embodiment, the propaganda detection unit 70 can employ a propaganda transformer 70A having a transformer architecture that employs a neural network to process the enriched prompt 50 and to generate an output. The output can be received by a propaganda detection classifier unit 70B configured to detect or identify propaganda in the output and to classify the propaganda. Specifically, the propaganda detection classifier unit 70B can employ one or more techniques to identify the propaganda, including natural language processing, sentiment analysis, and machine learning techniques. The propaganda transformer can employ a fine-tuned and optionally trained model that can be used for propaganda analysis, detection, and classification. The output of the propaganda transformer within the context of the system 10 is a processed version of the classified, enriched, and catalogued prompts that have been analyzed for elements indicative of propaganda. The transformer architecture, employing neural network techniques, analyzes the language, structure, and source of the prompt to identify features associated with propaganda, such as biased language, emotionally charged terms, evidence of bias, geo-location context from where the prompt originated, oversimplification or exaggeration of issues, and logical fallacies. This processed data is aimed at highlighting the aspects of the prompt that potentially align with propaganda (e.g., information aimed at influencing or manipulating opinions or promoting a particular agenda or ideology). Furthermore, the output may also include categorization or tagging of the identified propaganda elements, providing a detailed breakdown of the types of propaganda detected (e.g., emotional manipulation, biased language, oversimplification, etc.).

The propaganda detection classifier unit 70B can analyze the language, tone, and style of the enriched prompt 50, as well as the context in which the enriched prompt 50 is presented, in order to determine whether it is likely to contain propaganda. The propaganda detection unit 70 can then generate an output signal that is indicative of a classification or score indicating the likelihood that the content of the enriched prompt 50 contains propaganda. According to one practice, the enriched prompts can be further classified. Examples of suitable classifications for propaganda can include an emotional manipulation category, a misinformation category, an oversimplification category, a cherry-picking category, and a false dilemma category. For toxicity, the categories can include an offensive language category, a hate speech category, a personal attacks category, a stereotyping category, and a bullying category. For polarity, the categories can include a strongly positive category, a neutral category, and a strongly negative category. The output signal of the propaganda detection unit 70 can take various forms, including a binary classification signal (e.g., propaganda or not propaganda), a multi-class classification signal (e.g., propaganda vs. different types of non-propaganda content), or a probability or likelihood score indicating the likelihood of propaganda. According to one embodiment, the propaganda detection unit 70 outputs a propaganda score 72 that is indicative of the degree of likelihood that the enriched prompt 50 contains or includes propaganda.

The illustrated prompt language filtering unit 62 can also include a polarity detection unit 74 for detecting the presence of polarity in the enriched prompt 50. As used herein, the term “polarity” is intended mean a bias or emotional tone or sentiment that is present within the language of a prompt. As such, the sentiment can be positive, negative, or neutral in tone. For example, positive language can be used to express hope, optimism, or gratitude, while negative language can express anger, frustration, or disappointment. The polarity detection unit 74 can utilize a polarity transformer 74A having a transformer architecture that employs a neural network to process the enriched prompt 50 and to generate an output. The output of the polarity detection unit can be a classification or score indicating the sentiment associated with the enriched prompt 50 as being, for example, positive, negative, or neutral, based on an analysis performed by a fine-tuned polarity transformer leveraging neural network technique. The output can be received by a polarity detection classifier unit 74B to detect or identify polarity in the output and to classify the output. The polarity detection classifier unit 74B can employ a natural language processing technique to classify the polarity of the output (e.g., the enriched prompt 50) as being positive, negative, or neutral. The polarity detection classifier unit 74B can automatically identify the overall sentiment expressed in the enriched prompt 50. The polarity detection classifier unit 74B can then generate an output signal in the form of a polarity score 76 that is indicative of the degree of positivity or negativity (e.g., polarity) in the enriched prompt 50. The output signal of the polarity detection unit 74 can take various other forms, including a binary classification signal (e.g., polarity detected or polarity not detected), a probability or likelihood score indicating the likelihood of polarity or a type of polarity. The polarity detection classifier unit 74B can be configured to classify the enriched prompt by analyzing and identifying an overall sentiment associated with the prompt as being either positive, negative, neutral, slightly positive/negative for mild sentiment levels, mixed sentiment for prompts containing both positive and negative tones, or fact-based for content that is factual and neutral. After this classification, the unit can generate a polarity score indicative of a quantitative degree and type of sentiment observed with the prompt. This ensures a comprehensive sentiment analysis, accounting for nuanced and complex expressions within the enriched prompt and allows for a detailed understanding and quantification of the prompt's sentiment.

The illustrated prompt language filtering unit 62 can also include a toxicity detection unit 78 for detecting the presence of toxicity in the enriched prompt 50. As used herein, the term “toxicity” is intended mean language present within a prompt that is determined to be harmful, offensive, or hurtful to others, and can include insults, threats, and derogatory remarks. The toxicity detection unit 78 is configured to automatically identify text within the enriched prompt 50 that is determined to be harmful, offensive, or inappropriate. The toxicity detection unit 78 can employ a toxicity transformer 78A having a transformer architecture that employs a neural network to process the enriched prompt 50 and to generate an output. The toxicity transformer is a fine-tuned model used for toxicity analysis, detection, and classification. The output can be received by a toxicity detection classifier unit 78B that is configured to detect or to identify toxicity in the output and to classify the output. The toxicity detection classifier unit 78B can employ a natural language processing technique to classify the toxicity of the language and to predict the level of toxicity in the enriched prompt 50. The toxicity detection classifier unit 78B can then generate an output signal in the form of a toxicity score 80 that is indicative of the degree of toxicity in the enriched prompt 50. The output signal of the toxicity detection unit 78 can take various other forms, including a binary classification signal (e.g., toxicity detected or toxicity not detected) or a probability or likelihood score indicating the likelihood of toxicity in an enriched prompt 50. The toxicity detection classifier unit 78B can be configured to discern and classify varying degrees and types of toxic content, such as offensive language, hate speech, personal attacks, stereotyping, and bullying. Upon identifying the presence of such elements, the toxicity detection classifier unit 74B categorizes and adds metadata to the enriched prompt, distinguishing between the various toxic content types to provide a nuanced understanding of the nature of the toxicity. Further, the toxicity detection classifier unit can generate a toxicity score that quantitatively reflects the level of toxicity detected within the prompt.

The prompt language filtering unit 62 can also include an existing prompt detection unit 64 for identifying or determining the similarity of the enriched prompt 50 to an existing prompt. The existing prompt detection unit 64 can optionally operate by searching other available works or prompts on the blockchain, the internet, other references databases, or from other sources. The existing prompt detection unit 64 can optionally operate by identifying an attribute (e.g., a fingerprint with various key features) of the enriched prompt 50 and comparing those attributes to existing prompts or other works. The existing prompt detection unit 64 can optionally operate by employing one or more text analysis techniques and based on one or more characteristics of the enriched prompt 50 and the author. For example, the existing prompt detection unit 64 can compare the writing style of an unknown author to a set of known authorship characteristics or attributes forming part of a profile in order to detect plagiarism by comparing the enriched prompt 50 to selected ones of the authorship profiles. The text analysis techniques can assume that each author has a unique writing style, which can be characterized by various linguistic and stylistic features, such as sentence length, vocabulary, use of punctuation, and grammatical patterns. By comparing the enriched prompt 50 to a set of known authorship characteristics in the profile, the technique can identify similarities and differences in these characteristics and determine based thereon whether a risk of plagiarism is present. The existing prompt detection unit 64 can generate as an output a similarity score 68 that is indicative of the similarity of the enriched prompt 50 to a preexisting prompt. The similarity score 68 can be generated by analyzing and comparing the linguistic and stylistic features of the enriched prompt against the catalog that includes existing prompts or authorship profiles and can employ a text analysis technique to assess attributes such as sentence length, vocabulary, punctuation use, and grammatical patterns. The similarity score can also be generated by leveraging enriched metadata (e.g., themes, keywords, and conceptual tags) associated with the enriched prompt, comparing the metadata against those of existing prompts to identify matches and assess the degree of similarity thereto.

The output scores from the existing prompt detection unit 64, the propaganda detection unit 70, the polarity detection unit 74, and the toxicity detection unit 78 are conveyed to a scoring unit 66. Additionally, an ontology input 75 from the otology models 22 can optionally be conveyed to the scoring unit 66, and the ontology input 75 can be used as a basis for adjusting scoring weights. As illustrated in FIG. 1, the scoring unit 66 can determine and generate an overall or aggregated prompt filtering score 84 based on the similarity score 68, input propaganda score 72, the polarity score 76, and the toxicity score 80. The prompt filtering score 84 can be determined by summing together the foregoing input scores, although any selected type of mathematical operation can be performed to create the aggregated prompt filtering score 84. The prompt filtering score 84 can be indicative of the truthfulness of the enriched prompt 50 or the truthfulness of models generated from the enriched prompt 50. The scoring unit 66 can also optionally employ a weighting unit that can weigh the input scores based on one or more factors, such as domain, enterprise setting, and the like. The prompt filtering score 84 can be stored in the blockchain 52 and can be associated with the enriched prompt 50. The prompt filtering score 84 can also optionally be stored in metadata associated with the enriched prompt 50, which in turn can be stored in the blockchain 52. Further, the filtered prompts generated by any portion of the prompt filtering unit 60 can also be stored in the blockchain 52.

The illustrated prompt capture and enrichment system 10 can further include a prompt matching unit 90 for matching together one or more of the captured prompts 18B with one or more of the enriched prompts 50 that are stored in the blockchain 52. Further, the prompt matching unit 90 can receive additional types of data in addition to the captured prompts 18B. The illustrated prompt matching unit 90 can employ a prompt recommendation unit 110 for recommending one or more of the enriched prompts 50 to a use based on selected factors or parameters, such as user information and/or prompt attribute information. The user information an include age, occupation, similarity of prompt attributes, similarity of the user to authors of other prompts, previous viewing history of the user, similarity of the user created prompts to prompts generated by other authors, presence of selected language, such as keywords and context, within the prompt, the geographic location of the user, and the like. The prompt attributes can include, for example, contextual information, metadata, syntax, language similarities, frequency of use (e.g., popularity), and the like.

The prompt recommendation unit 110 can optionally include a multi-factorial cohort matching unit 94 for recommending one or more of the stored prompts (e.g., enriched prompts or filtered prompts) in the blockchain 52 with one or more users based on the enrichment information (e.g., attributes) associated with the enriched prompt 50. The multi-factorial cohort matching unit 94 can provide prompt recommendations based on the specific user. For example, the matching unit 94 can provide a recommendation for an enriched prompt based on user specific or identification information. The user information can include the age or occupation of the user, which can be used to generate recommendations, and this user information can be used to identify an enriched prompt 50 from an author having similar attributes. Several other types of user information can be used to generate a prompt recommendation. For example, the previous viewing history of the user can be employed by the multi-factorial cohort matching unit 94 to identify further data for the user, and this can be compared to available information for a prompt author or information in available enriched prompts 50 to identify and recommend an enriched prompt 50.

The prompt recommendation unit 110 can also optionally include a prompt similarity recommender unit 96 that can be configured to recommend enriched prompts 50 to a user based on other types of user information, such as the similarity of the stored enriched prompts 50 to prompts that were previously used or preferred by the user. The similarities between the prompts can be determined based on the writing style within the prompts, the presence of certain keywords or similar words in prompts, similar contexts, similar author or provider attributes, similar classifications, and the like.

The prompt recommendation unit 110 can further optionally include an in-the-moment recommender unit 98 that can be configured to recommend enriched prompts 50 to a user based on other selected types of user information, such as the current input provided by the user. Specifically, the in-the-moment recommender unit 98 can provide prompt suggestions or recommendations to the user in real-time, as they are interacting with the system 10. As such, the in-the-moment recommender unit 98 can provide relevant and useful prompt recommendations based on the user's current context and determined or extrapolated needs.

The illustrated prompt recommendation unit 110 can also optionally include a geofenced prompt recommendation unit 100 for recommending a captured prompt 18B or enriched prompt 50 to a user based on the location of the user. Specifically, the geofenced prompt recommendation unit 100 can recommend one or more of the enriched prompts 50 stored in the blockchain 52 to the user as a function of the geographic location of the user. The recommended prompts can be specific to the location of the user. Consequently, the geofenced prompt recommendation unit 100 can recommend prompts that are personalized and relevant to the user's physical location. For example, where a user is located in or near a baseball stadium, then this can provide context that can be considered in identifying relevant prompts.

The illustrated prompt matching unit 90 can also optionally include a simple context prompt matching unit 92 that can apply a rule-based approach to detecting prompts 18B and then matching the prompt 18B with one or more of the enriched prompts 50 stored in the blockchain 52 to determine a best match. The simple context prompt matching unit 92 thus determines a match score by comparing one or more characteristics or attributes of the prompt 18B with one or more characteristics or attributes of the enriched prompts 50 stored in the blockchain 52 to determine a match score. The types of attributes analyzed for matching can include, for example, thematic relevance, domain area, target user characteristics, keyword similarity, and contextual parameters, such as topic or subject area. For example, if the prompt pertains to for example “renewable energy solutions,” the prompt would be matched against enriched prompts that also focus on renewable energy, utilizing keywords and themes related to this subject to determine the best match score. As such, the blockchain 52 can store a set or catalog of enriched prompts 50 that can be employed by the prompt matching unit 90. The rule-based approach may detect enriched prompts 50 by searching for selected types of attributes, such as keywords that are present in the input prompt 18B and the enriched prompt 50, by identifying commonalities in metadata for the input prompt 18B and the enriched prompt 50, by identifying other similarities in language, syntax, and other features of the writing styles in the input prompt 18B and the enriched prompt 50. The rule-based approach can also operate in other ways.

The prompt matching unit 90 can also optionally include a trending prompt unit 102 for identifying the enriched prompts 50 from the blockchain 52 based on selected attribute data, such as popularity attribute data. The popularity attributes can include attribute features such as frequency of prompt use, velocity data indicative of a rate of change of the frequency of use, engagement metrics, especially associated with social media, such as likes, shares, comments and the like, sentiments associated with the prompts (e.g., likes or dislikes), relevancy or contextual data including the relevance of the prompt to current events, user information, popularity data, ratings provided by users or subject matter experts, and the like. The popularity level for one prompt may be determined relative to the popularity level of other prompts. The trending prompt unit 102 can optionally rank a plurality of the enriched prompts based on the popularity attributes associated therewith, and the higher ranked prompts can be selected as trending prompts. The trending prompt unit 102 can determine and rank enriched prompts based on popularity attributes and data by analyzing third party data, such as social media sites, news sites, forums, blogs, and other content repositories and the like.

An authorship profile encapsulates a combination of linguistic and stylistic features extracted from texts, such as sentence structure, word usage, and writing patterns, to identify or verify the author of a given piece of text. The prompt matching unit 90 can further optionally include an authorship profile matching unit 104 that can be configured to employ a text analysis technique to analyze and determine the author of the enriched prompt 50 and the author of the input prompt 18B by analyzing the language associated with each, and then match the authors of the prompts if a match exists. For example, the authorship profile matching unit 104 can identify or determine the author of the enriched prompt 50 by employing one or more text analysis techniques (e.g., natural language processing technique) that analyzes one or more distinctive language attributes of the enriched prompt 50 to determine the author therefrom. By way of example, the authorship profile matching unit 104 can compare the writing style of an unknown author of a prompt to a set of known authorship characteristics forming part of an author profile, which can include sentence structure, use of unique phrases, and stylistic nuances, to identify the most likely author of the prompt. The text analysis techniques can be configured to assume that each author has a unique writing style, which can be characterized by various linguistic and stylistic features, such as sentence length, vocabulary, use of punctuation, and grammatical patterns. By comparing the prompt attributes of one prompt to a set of known authorship characteristics in the author profile of another prompt, the text analysis technique can identify similarities and differences in these attributes and determine based thereon which known authorship profile is the closest match to the input prompt 18B. This detailed comparison allows for an enhanced understanding of authorship beyond mere surface-level characteristics, delving into the intricacies of individual writing styles. The authorship profile matching unit 104 can thus be employed to detect plagiarism by comparing the input prompt 18B to selected ones of the authorship profiles associated with the enriched prompts 50 to determine if a match exists. According to one embodiment, the authorship profile matching unit 104 can determine and assign a matching score based on the comparison results, where the matching score is indicative of a degree of similarity between the authorship profiles of the two input and enriched prompts. The matching score, which can be based for example on a scale from 0 (no similarity) to 1 (perfect similarity), can help quantify the degree of authorship alignment, matching or similarity. Further, depending on the specific application, a threshold score can be applied to determine whether the prompts are deemed to have a sufficiently similar authorship profile. The threshold-based approach facilitates the operationalization of similarity metrics, ensuring that authorship matches meet a predefined standard of similarity. If the similarity score exceeds the threshold score or value, the prompts may be considered to have matching authorship profiles. As such, the output of the authorship profile matching unit 104 may include the similarity score, as well as any additional metadata or annotations relevant to the comparison. Consequently, the output of the authorship profile matching unit offers a similarity score but also provides a rich, metadata-enriched profile of the authorship comparison, offering insights into the unique authorship fingerprints of the compared prompts. The output of the authorship profile matching unit 104 can be stored in the blockchain 52 ensuring the permanence and verifiability of the authorship analysis.

The system of the present invention significantly enhances the utility and effectiveness of prompts used in generative AI or language models through a comprehensive system and method that captures, enriches, filters, and catalogues prompts, leading to robust and high-quality outputs. The advantages of the system of the present invention an include a system that actively captures, enriches (e.g., with metadata) and catalogues prompts from various multi-sided sources, improving the relevance and effectiveness of prompts for the users' specific needs. This is further enhanced by employing caching and high availability (HA) techniques, enabling super-fast matching and retrieval of prompts at runtime, thereby simplifying the process of identifying suitable prompts and significantly reducing response times. The system 10 can also ensure a high standard of trust and safety by continuously and rigorously assessing the integrity and appropriateness of the input or enriched prompts. Through a truthfulness assessment, the system 10 can filter out prompts identified with potential trust and safety concerns or issues, including those with low truthfulness scores due to issues like copyright violations, plagiarism, and the presence of propaganda, toxicity, or inappropriate polarity. This proactive prompt analysis approach safeguards against the dissemination of harmful or misleading content, enabling the system to uphold relatively high standards of content quality and user safety.

The system of the present invention can also employ blockchain technology to ensure tamper-proof lineage and veracity of stored prompts, establishing a secure and immutable record of prompt creation, enrichment, and modification history. Each prompt stored in the blockchain ledger can be associated with one or more Non-Fungible Tokens (NFTs), endowing individual prompts with unique identifiers that certify their authenticity, ownership, and originality. This mechanism not only enhances the security and accessibility of data but also introduces a novel means of prompt verification and rights management, ensuring a reliable and verifiable storage solution. The system 10 also incorporates verified interactions with advanced knowledge assets, including AI Knowledge Assistants, Embeddings, and AI Agents, ensuring safe and authenticated access to these resources. This integration allows users to summon knowledge assets in a trusted manner, leveraging their capabilities for enhanced sourcing, cataloging, discovery, and matching of prompts. The verification performed by the system 10 ensures that these interactions are not only efficient but also safeguarded against unauthorized access or misuse, promoting a trusted and reliable environment for engaging with AI-powered tools and enhancing the overall quality and relevance of generated content.

The system 10 of the present invention can also employ advanced, multi-faceted approaches to prompt matching, including Multi-Factorial Cohort Match, In-the-Moment Recommender, Prompt Similarity Recommender, Geofenced Prompt Recommendation, and Authorship Profile Matching Unit, which evaluates linguistic, temporal, and geographical factors. This sophisticated matching system ensures that prompts are not only relevant to the specific context of the inquiry but also tailored to the unique characteristics of the user cohort, the immediacy of their needs, the similarity to previously successful prompts, the geographical relevance of the content, and the distinctive authorship style of the content creators. This comprehensive, context-aware approach significantly enhances the precision and applicability of prompt recommendations, ensuring users receive the most relevant, timely, and geographically pertinent content, all while aligning with the unique linguistic and stylistic signatures of the content they engage with. Overall, the system 10 creates a more dynamic, intelligent, and user-centric approach, making the system faster, more robust, and better capable of delivering enhanced and pertinent (e.g., better) outputs, thereby significantly improving the generative AI model interaction experience.

It is to be understood that although the invention has been described above in terms of particular embodiments, the foregoing embodiments are provided as being illustrative only, and are not intended to limit or define the scope of the invention. Various other embodiments, including but not limited to those described herein are also within the scope of the claims and current invention. For example, the foregoing elements, units, modules, tools, and components described herein can be further divided into additional components or sub-components or joined together to form fewer components for performing the same functions.

Any of the functions disclosed herein can be implemented using means for performing those functions. Such means include, but are not limited to, any of the components or units disclosed herein, as well as known electronic and computing devices and associated components.

The techniques described herein can be implemented, for example, in hardware, one or more computer programs tangibly stored on one or more computer-readable media, firmware, hardware or any combination thereof. The techniques described herein can be implemented in one or more computer programs executing on (or executable by) a programmable computer or electronic device having any combination of any number of the following: a processor, a storage medium readable and/or writable by the processor (including, for example, volatile and non-volatile memory and/or storage elements), an input device, an output device, and a display. Program code can be applied to input entered using the input device to perform the functions described and to generate output using the output device.

The term computing device or electronic device as used herein can refer to any device, such as a computer, smart phone, server and the like, that includes a processor and a computer-readable memory capable of storing computer-readable instructions, and in which the processor is capable of executing the computer-readable instructions in the memory. The terms electronic device, computer system and computing system refer herein to a system containing one or more computing devices that are configured to implement one of more units, modules, or components of the prompt capture and enrichment system 10 of the present invention.

Embodiments of the present invention include features which are only possible and/or feasible to implement with the use of one or more computers or servers, processors, and/or other elements of a computer or server system. Such features are either impossible or impractical to implement mentally and/or manually. For example, embodiments of the present invention can operate on digital electronic processes which can only be created, stored, modified, processed, and transmitted by computing devices and other electronic devices. Such embodiments, therefore, address problems which are inherently computer-related and solve such problems using computer technology in ways which cannot be solved manually or mentally by humans.

Any claims herein which by implication or affirmatively require an electronic device such as a computer or server, a processor, a memory, storage, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claims herein which recites that the claimed method is performed by a computer, a processor, a memory, and/or similar computer-related element, is intended to, and should only be interpreted to, encompass methods which are performed by the recited electronic device or computer-related element(s). Such a method claim should not be interpreted, for example, to encompass a method that is performed mentally or by hand (e.g., using pencil and paper). Similarly, any product or computer readable medium claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to enrich and manage prompts. There is no analog to this problem in the non-computer environment, nor is there an analog to the solutions disclosed herein in the non-computer environment.

Furthermore, embodiments of the present invention represent improvements to computer and communication technology itself. For example, the prompt capture and enrichment system 10 of the present invention can optionally employ a specially programmed or special purpose computer in an improved computer system, which can, for example, be implemented within a single computing device. In the present invention, the prompt capture and enrichment system 10 of the present invention results in an improved and enhanced computing system that better enables the user to capture, enrich and filter prompts to produce a more refined output from a generative language model. The prompt capture and enrichment system 10 thus results in a specially configured computing system. The prompt capture and enrichment system 10 also improves the ability to capture prompts a wider variety of sources, improves the ability to enrich the prompts by employing ontology models, contextual enrichment mechanisms, classifier and authorship profiling techniques, and multi-dimensional consent management techniques. The system of the present invention also improves the ability to filter prompts by employing prompt language filtering and detection units, and then employing a scoring unit to score the prompts. Consequently, the prompt capture and enrichment system 10 by employing the units set forth herein increases the efficiency of the overall systems and increases the efficiency of enriching prompts thus resulting in improved performance and enhanced functionality of generative language models.

Each computer program within the scope of the claims below can be implemented in any programming language, such as assembly language, machine language, a high-level procedural programming language, or an object-oriented programming language. The programming language can, for example, be a compiled or interpreted programming language.

Each such computer program can be implemented in a computer program product tangibly embodied in a machine-readable storage device for execution by a computer processor. Method steps of the invention can be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing can be supplemented by, or incorporated in, specially designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which can be used in conjunction with any digital print engine or marking engine, display monitor, or other raster output device capable of producing color or gray scale pixels on paper, film, display screen, or other output medium.

Any data disclosed herein can be implemented, for example, in one or more data structures tangibly stored on a non-transitory computer-readable medium. Embodiments of the invention can store such data in such data structure(s) and read such data from such data structure(s).

It should be appreciated that various concepts, systems and methods described above can be implemented in any number of ways, as the disclosed concepts are not limited to any particular manner of implementation or system configuration. Examples of specific implementations and applications are discussed herein are primarily for illustrative purposes and for providing or describing the operating environment of the system of the present invention. The prompt capture and enrichment system 10 and/or elements or units thereof can employ one or more electronic or computing devices, such as one or more servers, clients, computers, laptops, smartphones and the like, that are networked together, or which are arranged so as to effectively communicate with each other. The network can be any type or form of network. The devices can be on the same network or on different networks. In some embodiments, the network system can include multiple, logically grouped servers. In one of these embodiments, the logical group of servers can be referred to as a server farm or a machine farm. In another of these embodiments, the servers can be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like. The prompt capture and enrichment system 10 and/or any associated units or components of the system can employ one or more of the illustrated computing or electronic devices and can form a computing system. Further, the server can be a file server, application server, web server, proxy server, appliance, network appliance, gateway, gateway server, virtualization server, deployment server, SSL VPN server, or firewall, or any other suitable electronic or computing device. In one embodiment, the server can be referred to as a remote machine or a node. In another embodiment, a plurality of nodes can be in the path between any two communicating servers or clients.

What is claimed:

1. A computer-implemented prompt capture and enrichment system for capturing and enriching prompts for use in a generative language model, comprising
a prompt capture unit for receiving a plurality of the prompts from a plurality of different data sources to form input prompts,
a prompt enrichment unit for automatically enriching one or more prompt attributes of the input prompts and for generating a plurality of enriched prompts,
a prompt filtering unit for filtering the plurality of enriched prompts based on one or more of the prompt attributes for generating a plurality of filtered prompts and for generating a truthfulness score associated with the filtered prompt indicative of the truthfulness of the filtered prompts,
a prompt matching unit for matching one or more of the plurality of enriched prompts or filtered prompts with one or more of the input prompts to determine if a match exists based on user information and one or more of the prompt attributes, and
a storage unit including a blockchain for storing one or more of the plurality of input prompts, the plurality of enriched prompts, and the plurality of filtered prompts.

2. The computer-implemented system of claim 1, wherein the prompt enrichment unit comprises an ontology model unit for storing a plurality of ontology models that are domain specific and for applying one or more of the plurality of ontology models to one or more of the plurality of input prompts, wherein the ontology model is related to the input prompts based on an analysis of the prompt attributes and identifies one or more relevant concepts, entities or relationships in the ontology model that are related to the input prompt, and wherein the ontology model unit generates an ontology prompt.

3. The computer-implemented system of claim 2, wherein the prompt enrichment unit further comprises a prompt enrichment subsystem for enriching the ontology prompts by adding one or more prompt attributes thereto and for generating the plurality of enriched prompts.

4. The computer-implemented system of claim 3, wherein the prompt enrichment subsystem comprises two or more of:
a prompt context enrichment unit for receiving the ontology prompt and for enriching one or more contextual attributes of the ontology prompt with contextual data to enrich the ontology prompt,
an auto-prompt classifier unit for automatically classifying the ontology prompt into one or more categories based on one or more of the prompt attributes,
a prompt efficacy predictor unit for applying to the ontology prompt one or more machine learning models to predict an effectiveness of the ontology prompt in generating a relevant and accurate output by the generative language model,
a multi-factorial authorship profiling unit for identifying an author of the ontology prompt by analyzing multiple different language related prompt attributes of the ontology prompt and then determining the author thereof, and
a multi-dimensional consent management unit for analyzing rights attributes associated with the ontology prompt to ensure that the user has one or more rights in the ontology prompt.

5. The computer-implemented system of claim 4, wherein the auto-prompt classifier unit employs a categorization specific machine learning model to categorize the ontology prompts into one or more of the categories, wherein the categorization specific machine learning model is pretrained on a plurality of prelabeled input prompts and corresponding categories that include the prompt so as to be able to select an accurate category for the ontology prompt.

6. The computer-implemented system of claim 5, wherein the prompt efficacy predictor unit includes an efficacy related machine learning model to determine a relevance of an output of the generative language model based on the ontology prompt, and wherein the efficacy related machine learning model is pretrained on prompts and related outputs so as to analyze one or more attributes of the ontology prompt to predict a relevance of the output of the generative language model processing the ontology prompt.

7. The computer-implemented system of claim 4, wherein the prompt enrichment unit further comprises a prompt validation unit for receiving and processing one or more of the enriched prompts and for evaluating and validating a selected prompt attribute of the enriched prompt.

8. The computer-implemented system of claim 7, wherein the prompt enrichment subsystem further comprises a digital conversion unit for converting one or more of the input prompts and one or more of the plurality of enriched prompts into a digital asset.

9. The computer-implemented system of claim 4, wherein the prompt filtering unit further comprises
a prompt language filtering unit for filtering the language of the plurality of the enriched prompts and for generating an output language truthfulness score indicative of the degree of truthfulness in the language of the enriched prompt,
an existing prompt detection unit for determining the similarity of the enriched prompt to the input prompt and for generating an output similarity score that is indicative of the similarity of the enriched prompt to the preexisting prompt, and
a scoring unit for generating an aggregated truthfulness score based on the truthfulness score generated by the prompt language filtering unit and on the similarity score generated by the existing prompt detection unit.

10. The computer-implemented system of claim 9, wherein the prompt language filtering unit comprises one or more of:
a propaganda detection unit for detecting the presence of propaganda within the language of the enriched prompt and for generating a propaganda score that is indicative of a degree of likelihood that the enriched prompt includes propaganda,
a polarity detection unit for detecting the presence of polarity in the language of the enriched prompt and for generating a polarity score that is indicative of a degree of polarity in the enriched prompt, and
a toxicity detection unit for detecting the presence of toxicity in the language of the enriched prompt and for generating a toxicity score that is indicative of a degree of toxicity in the enriched prompt.

11. The computer-implemented system of claim 10, further comprising a prompt matching unit for matching together one or more of the input prompts with one or more of the enriched prompts.

12. The computer-implemented system of claim 11, wherein the prompt matching unit comprises a prompt recommendation unit for recommending one or more of the enriched prompts to a user.

13. The computer-implemented system of claim 12, wherein the prompt recommendation unit comprises two or more of:
a multi-factorial cohort matching unit for recommending one or more of the enriched prompts to one or more users based on the attributes associated with the enriched prompt and based on selected user information,
a prompt similarity recommender unit for recommending one or more of the enriched prompts to the user based on a similarity of the enriched prompts to one or more other prompts used by the user,
an in-the-moment recommender unit for recommending one or more of the enriched prompts to the user based on user input provided by the user, and
a geofenced prompt recommendation unit for recommending one or more of the enriched prompts to the user based on a location of the user.

14. The computer-implemented system of claim 13, wherein the prompt matching unit further comprises one or more of:
a simple context prompt matching unit for detecting input prompts and then matching one or more of the input prompts with one or more of the enriched prompts by determining a best match score by comparing one or more prompt attributes of the input prompt with one or more prompt attributes of the enriched prompt,
a trending prompt unit for identifying one or more of the enriched prompts that are popular based on one or more popularity attributes associated with the enriched prompts, and
an authorship profile matching unit employing a text analysis technique for analyzing language attributes associated with each of the enriched prompt and the input prompt and then identifying an author of the enriched prompt based thereon.

15. A computer-implemented method for capturing and enriching prompts, the method comprising:
receiving a plurality of input prompts from a plurality of different data sources, enriching one or more prompt attributes of the input prompts and for generating based thereon a plurality of enriched prompts,
filtering the plurality of enriched prompts based on one or more of the prompt attributes and generating in response a plurality of filtered prompts, and for generating a truthfulness score associated with the filtered prompts indicative of a truthfulness of the enriched prompts,
matching one or more of the plurality of enriched prompts or filtered prompts with one or more of the input prompts to determine if a match exists based on user information and one or more of the prompt attributes, and
storing one or more of the plurality of captured prompts, the plurality of enriched prompts, and the plurality of filtered prompts.

16. The computer-implemented method of claim 15, further comprising
storing a plurality of ontology models that are domain specific and applying one or more of the plurality of ontology models to one or more of the plurality of input prompts, wherein the ontology model is related to the input prompts based on an analysis of the prompt attributes and identifies one or more relevant concepts, entities or relationships in the ontology model that are related to the input prompt, and
generating in response an ontology prompt.

17. The computer-implemented method of claim 16, further comprising enriching the ontology prompts by adding one or more prompt attributes thereto and generating the plurality of enriched prompts.

18. The computer-implemented method of claim 17, further comprising
receiving the ontology prompt, and
enriching the ontology prompt with contextual data to enhance the ontology prompt.

19. The computer-implemented method of claim 18, further comprising automatically classifying the ontology prompt into one or more categories based on one or more of the prompt attributes.

20. The computer-implemented method of claim 19, further comprising
receiving the ontology prompt, and
applying to the ontology prompt one or more machine learning models to predict an effectiveness of the ontology prompt in generating a relevant and accurate output by the generative language model.

21. The computer-implemented method of claim 20, further comprising identifying an author of the ontology prompt by analyzing multiple different language related prompt attributes of the ontology prompt and then determining the author thereof.

22. The computer-implemented method of claim 21, further comprising
receiving one or more of the enriched prompts,
processing one or more of the enriched prompts,
evaluating and validating a quality of the one or more of the enriched prompts.

23. The computer-implemented method of claim 21, further comprising employing a categorization specific machine learning model to categorize the ontology prompts into one or more of the categories, wherein the categorization specific machine learning model is pretrained on a plurality of prelabeled input prompts and corresponding categories that include the prompt so as to be able to select an accurate category for the ontology prompt.

24. The computer-implemented method of claim 23, further comprising
determining a relevance of an output of the generative language model based on the ontology prompt, and
employing an efficacy related machine learning model that is pretrained on prompts and related outputs so as to analyze one or more attributes of the ontology prompt to predict a relevance of the output of the generative language model processing the ontology prompt.

25. The computer-implemented method of claim 24, further comprising
filtering a language attribute of the plurality of the enriched prompts, and
generating an output language truthfulness score indicative of the degree of truthfulness in the language of the enriched prompt.

26. The computer-implemented method of claim 25, further comprising
determining a similarity of the enriched prompt to the input prompt, and
generating an output similarity score that is indicative of the similarity of the enriched prompt to the preexisting prompt.

27. The computer-implemented method of claim 26, further comprising generating an aggregated truthfulness score based on the truthfulness score and on the similarity score.

28. The computer-implemented method of claim 27, further comprising
detecting the presence of propaganda within the language of the enriched prompt, and
generating a propaganda score that is indicative of a degree of likelihood that the enriched prompt includes propaganda.

29. The computer-implemented method of claim 28, further comprising
detecting the presence of polarity in the enriched prompt, and
generating a polarity score that is indicative of a degree of polarity in the enriched prompt.

30. The computer-implemented method of claim 29, further comprising
detecting the presence of toxicity in the enriched prompt, and
generating a toxicity score that is indicative of a degree of toxicity in the enriched prompt.

31. The computer-implemented method of claim 30, further comprising matching together one or more of the input prompts with one or more of the enriched prompts.

32. The computer-implemented method of claim 30, further comprising recommending one or more of the enriched prompts to a user.

33. The computer-implemented method of claim 32, further comprising at least one of
recommending one or more of the enriched prompts to one or more users based on the attributes associated with the enriched prompt and based on selected user information,
recommending one or more of the enriched prompts to the user based on a similarity of the enriched prompts to one or more other prompts used by the user,
recommending one or more of the enriched prompts to the user based on user input provided by the user, and
recommending one or more of the enriched prompts to the user based on a location of the user.

34. The computer-implemented method of claim 33, further comprising at least one of
detecting input prompts and then matching one or more of the input prompts with one or more of the enriched prompts by determining a best match score by comparing one or more prompt attributes of the input prompt with one or more prompt attributes of the enriched prompt
identifying one or more of the enriched prompts that are popular based on one or more popularity attributes associated with the enriched prompts, and
employing a text analysis technique for analyzing language attributes associated with each of the enriched prompt and the input prompt and then identifying an author of the enriched prompt based thereon.

35. A computer-implemented prompt capture and enrichment system for capturing and enriching prompts for use with a generative language model, comprising
an electronic memory, and
a computer processor coupled to the electronic memory, wherein the computer processor is programmed for:
capturing a plurality of the prompts from a plurality of different data sources,
enriching one or more of the plurality of prompts by manipulating one or more attributes of the prompts and for generating a plurality of enriched prompts, wherein the enriching of the prompt includes applying one or more predefined ontology models to the prompt to form an otology prompt, and further enriching the ontology prompt by performing one or more of
adding contextual information to the ontology prompt,
classifying the ontology prompt into one or more predefined categories of prompts,
automatically determining an efficacy of the ontology prompt, or
identifying an author of the ontology prompt by analyzing one or more different attributes of the ontology prompt, and
filtering language associated with the plurality of enriched prompts and generating a plurality of filtered prompts, and for generating a truthfulness score indicative of a truthfulness of the language of the plurality of enriched prompts,
matching one or more of the plurality of filtered prompts with one or more of the captured prompts, and
storing one or more of the plurality of captured prompts, the plurality of enriched prompts, and the plurality of filtered prompts,
wherein the enriching of the prompt results in enhanced performance and functionality of the generative language model.

36. The computer-implemented system of claim 35, wherein manipulating the one or more attributes of the prompt includes manipulating metadata associated with the prompt or adding contextual data to the prompt to clarify a scope and purpose of the prompt.

37. The computer-implemented system of claim 36, wherein the processor is further configured for:
processing one or more of a plurality of ontology models that are domain specific,
applying the one or more ontology models to one or more of the plurality of input prompts, wherein the ontology model is related to the input prompts based on an analysis of the prompt attributes and identifies one or more relevant concepts, entities or relationships in the ontology model that are related to the input prompt,
generating an ontology prompt, and
enriching the ontology prompt by adding one or more prompt attributes thereto and for generating the plurality of enriched prompts.

38. The computer-implemented system of claim 37, wherein the processor is further configured for:
enriching one or more contextual attributes of the ontology prompt with contextual data to enrich the ontology prompt,
automatically classifying the ontology prompt into one or more categories based on one or more of the prompt attributes,
applying to the ontology prompt one or more machine learning models to predict an effectiveness of the ontology prompt in generating a relevant and accurate output by the generative language model,
identifying an author of the ontology prompt by analyzing multiple different language related prompt attributes of the ontology prompt and then determining the author thereof, and
analyzing one or more rights attributes associated with the ontology prompt to ensure that the user has one or more rights in the ontology prompt.

39. The computer-implemented system of claim 38, wherein the processor is configured to:
employ a categorization specific machine learning model to categorize the ontology prompts into one or more of the categories, wherein the categorization specific machine learning model is pretrained on a plurality of prelabeled input prompts and corresponding categories that include the prompt so as to be able to select an accurate category for the ontology prompt, and
employ an efficacy related machine learning model to determine a relevance of an output of the generative language model based on the ontology prompt, and wherein the efficacy related machine learning model is pretrained on prompts and related outputs so as to analyze one or more attributes of the ontology prompt to predict a relevance of the output of the generative language model processing the ontology prompt.
